(19) United States
(12) Patent Application Publication
(10) Pub. No.: US 2005/0176547 A1
(43) Pub. Date: Aug. 11, 2005

(54) Continuously variable transmission system

(76) Inventor: Andrew Damian DeFreitas, Wigan (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/502,992

(22) PCT Filed: Jan. 28, 2003
(86) PCT No.: PCT/GB03/00332

(30) Foreign Application Priority Data
Feb. 1, 2002 (GB) 0202346.3

(51) Int. Cl. F16H 37/02

(52) U.S. Cl. 475/207

(57) ABSTRACT

A multi-regime continuously variable ratio transmission has an output shaft (16), a variator and epicyclic gear sets (E1, E2) arranged coaxially to provide drive to two coaxial output shafts (20, 26). The drive from the coaxial output shafts (20, 26) is selectively connectable to an offset system output shaft (22) by means of high-and low-regime clutches (H, L) arranged coaxially with the system output shaft (22).

The present invention relates to multi-regime, continuously variable ratio transmission (CVT) systems, for example for use in motor vehicles.

A CVT system of this type is disclosed in EP-A-0149892. The system disclosed therein has the advantage of being “coaxial”, i.e. with the system input and output shafts, the CVT unit (variator) and the two epicyclic gear trains being arranged coaxially, which has the advantages of compactness and simplicity. However, the space available for locating a transmission is often limited, particularly in smaller vehicles, and the use of a coaxial CVT system may not allow the drive to be transferred easily to the driven wheels.

In accordance with the present invention, there is provided a multi-regime continuously variable ratio transmission system comprising:
a system input shaft;
a continuously variable ratio transmission unit (variator) connected coaxially to the system input shaft and having a variator output arranged coaxially with the system input shaft;
gearing means connected coaxially to the system input shaft and the output of the variator and having first and second gearing output shafts arranged coaxially with the system input shaft;
a system output shaft offset from the system input shaft; and
first and second clutches arranged coaxially with the system output shaft to selectively couple the drive from the first and second gearing output shafts to the system output shaft.

The provision of a variator and gearing means coaxially in combination with an offset system output shaft provides many advantages.

Firstly, the variator has all the benefits of reduced length, improved compactness, and improved stiffness associated with a coaxial design while at the same time the offset system output shaft allows output to be taken from either or both ends of the shaft, which is particularly beneficial for four-wheel drive applications. Secondly, the present invention allows a potential length reduction as compared with wholly coaxial designs.

In one embodiment, the gearing means comprises a first mixing epicyclic gear train having inputs driven by the system input shaft and the variator and a first epicyclic output shaft arranged coaxialy with the system input shaft and forming the first gearing output shaft;
a second epicyclic gear train having an input driven by the system input shaft and a second epicyclic gear train output arranged coaxially with the system input shaft and forming the second gearing output shaft.

Preferably the system output shaft is aligned parallel to the system input shaft.

In one embodiment, the first and second clutches are selectively connectable to a common clutch output plate connected to the system output shaft.

The drives from the first and second epicyclic gear train output shafts are preferably transmitted to one side of the first and second clutches respectively.

Preferably, the first clutch is engaged to place the transmission in low regime and the second clutch is engaged to place the transmission in high regime.

The invention also includes a motor vehicle comprising a transmission system in accordance with the invention.

By way of example only, a specific embodiment of the present invention will now be described, with reference to the accompanying drawings, in which:

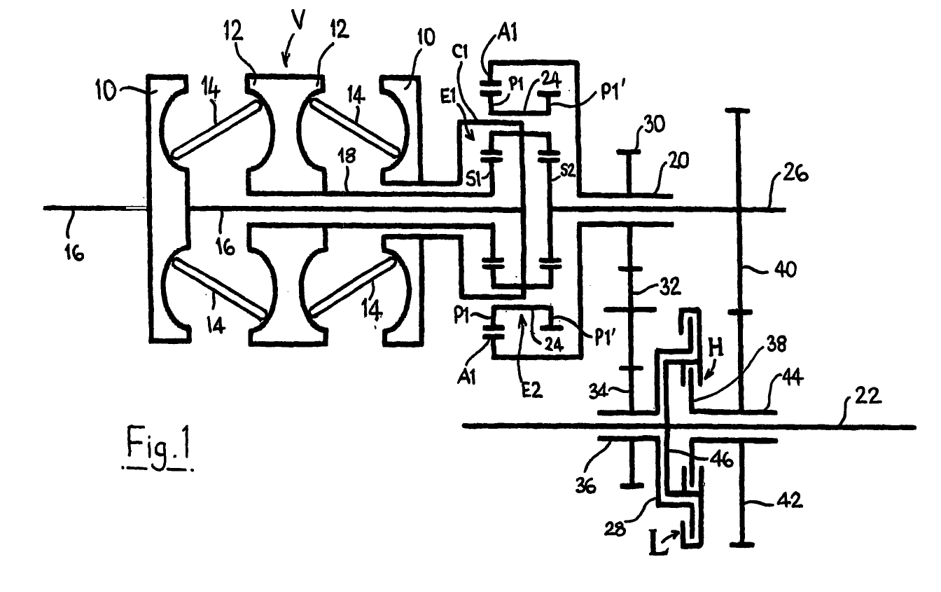

FIG. 1 is a diagrammatic illustration of an embodiment of continuously variable transmission in accordance with the present invention; and

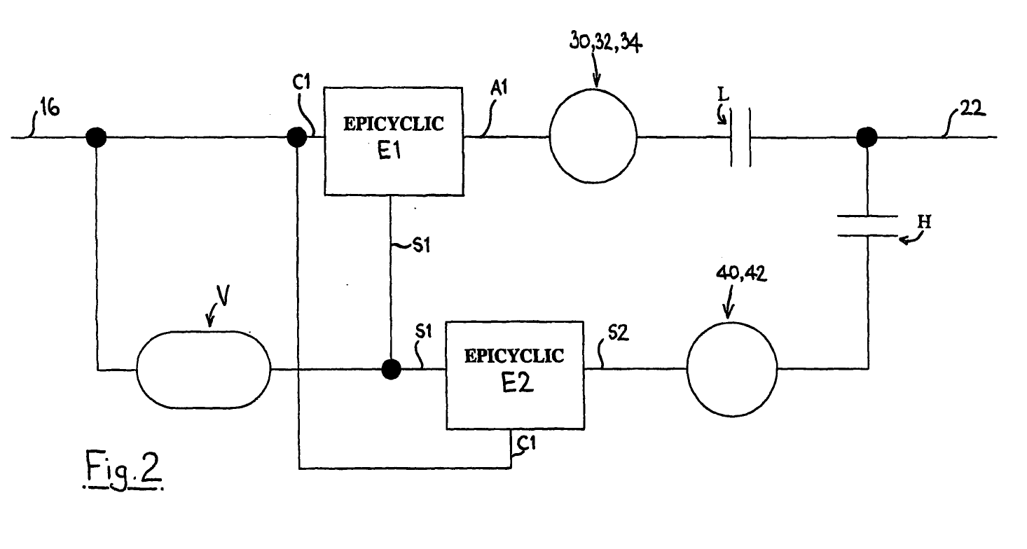

FIG. 2 is a diagram explaining the principles of operation of the transmission of FIG. 1.

Referring firstly to FIG. 1, a continuously variable ratio transmission comprises a variator V of the known toroidal race rolling traction type having two toroidally-recessed discs 10 arranged one at each end of the unit and a pair of similar output discs 12, each facing a respective one of the input discs 10 and rotating with each other. Sets of rollers 14 are mounted between the opposing faces of the input and output discs 10, 12 to transmit drive from the input discs 10 to the output discs 12 with a ratio which is variable by tilting the rollers 14.

The input discs 10 are connected to and driven by a system input shaft 16. The variator provides an output via a tubular variator output shaft 18 which is arranged coaxially with the input shaft 16. The end of the shaft 18 remote from the variator V drives the sun gear S1 of a first, mixing epicyclic gear train E1. The carrier C1 of the gear train E1 is connected to, and driven by, the input shaft 16 and carries planet gears P1 which mesh with an annulus A1 which is connected to a first intermediate tubular output drive shaft 20 arranged coaxially with the system input shaft 16. The first output drive shaft 20 is selectively connectable by means of a low-regime clutch L to a system output shaft 22, which is offset from, but parallel to, the system input shaft 16, as will be explained.

The sun gear S1, the planet gears P1 and the carrier C1 of the first epicyclic gear train E1 also form the input sun, planet gears and carrier respectively of a second epicyclic gear train E2. The spindles 24 on which the planet gears P1 are mounted also each carry a further gear P1′ at the opposite end, which meshes with an output sun gear S2 connected to a second intermediate output drive shaft 26 arranged coaxially with the system input shaft 16 and within the first intermediate output drive shaft 20. The planet gears P1, P1′ and/or the sun gears S1, S2 of the first and second epicyclic gear trains E1, E2, may be the same sizes (which would help to minimise cost) or different sizes (to realise a change in output ratio). The second intermediate drive shaft 26 is selectively connectable to the system output shaft 22 by means of a high regime clutch H, as will be explained.

Thus, the coaxial arrangement of the variator V and the two epicyclic gear trains E1, E2 produces two coaxial intermediate output shafts 20,26. The drive from the first intermediate output shaft 20 is transmitted from the shaft to one side 28 of the low regime clutch L by means of an output gear 30 located on the output shaft 20, an idler gear 32 (which reverses the direction of rotation) and to a clutch input gear 34 located on a tubular, low-regime clutch input shaft 36 arranged coaxially with the system output shaft 22.

The drive from the second intermediate output shaft 26 is transmitted from the shaft to one side 38 of the high regime clutch H by means of an output gear 40 located on the output shaft 26 and a high-regime clutch input gear 42 located on a tubular, high-regime clutch input shaft 44 arranged coaxially with the system output shaft 22.

By applying the low-regime or high-regime clutch L, H as required, the drive from the first intermediate output shaft 20 or the second intermediate output shaft 26 is transmitted to a common clutch plate 46 which rotates with the system output shaft 22. Thus, the drive from the first or second intermediate drive shaft 20, 26 can be transmitted to the system output shaft 22 by appropriate control of the clutches L, H.

The operation of the embodiment of FIG. 1 is illustrated schematically in FIG. 2.

The provision of a system output shaft 22 which is offset to a coaxial variator/epicyclic gear train assembly (V, E1, E2) allows the system output drive to be taken from either end of the system output shaft 22 (for front- and rear- wheel drive vehicles respectively) or from both ends of the output shaft (for four-wheel drive vehicles) as may be appropriate, yet still offers many of the advantages afforded by the coaxial variator/epicyclic gear train assembly.

The invention is not restricted to the details of the foregoing embodiment. For example, although the system output shaft 22 is described as being parallel to the system input shaft 16, it may be appropriate to incline the system output shaft 22 to the system input shaft 16, for example to suit the available space for the transmission. Furthermore, although the two clutches L, H are nested with each other (i.e. they are engagable with a common output plate 46), it may be appropriate to separate the clutches so that they are spaced apart along the length of the system output shaft 22.

Moreover, a variator other than a toroidal race rolling traction type variator could be used. Moreover, although a two-regime transmission has been described, the invention is equally applicable to three-or higher-regime transmission, by selection of appropriate additional epicyclic gearsets and regime clutches.

Also, depending on the required direction of rotation of the output shaft 22 the idler gearset 30, 32, 34 can be used as described for low regime output or alternatively could be used for high regime output, resulting in a reversal of the transmission output, in which case the low regime output wouuld be taken through a conventional, non-reversing gearset.

1. A multi-regime continuously variable ratio transmission system comprising:
a system input shaft;
a continuously variable ratio transmission unit (variator) connected coaxially to the system input shaft and having a variator output arranged coaxially with the system input shaft;
gearing means connected coaxially to the system input shaft and the output of the variator and having first and second gearing output shafts arranged coaxially with the system input shaft;
a system output shaft offset from the system input shaft; and
first and second clutches arranged coaxially with the system output shaft to selectively couple the drive from the first and second gearing output shafts to the system output shaft.

2. A transmission system as claimed in claim 1, wherein the gearing means comprises:
a first mixing epicyclic gear train having inputs driven by the system input shaft and the variator and a first epicyclic output shaft arranged coaxially with the system input shaft and forming the first gearing output shaft;
a second epicyclic gear train having an input driven by the system input shaft and a second epicyclic gear train output arranged coaxially with the system input shaft and forming the second gearing output shaft.

3. A transmission system as claimed in claim 1, wherein the system output shaft is aligned parallel to the system input shaft.

4. A transmission system as claimed in claim 1, wherein the first and second clutches are selectively connectable to a common clutch output plate connected to the system output shaft.

5. A transmission system as claimed in claim 1, wherein the drives from the first and second gearing output shafts are transmitted to one side of the first and second clutches respectively by means of gearing.

6. A transmission system as claimed in claim 1, wherein the first clutch is engaged to place the transmission in low regime and the second clutch is engaged to place the transmission in high regime.

7. A motor vehicle comprising a transmission system as claimed in claim 1.

8. A transmission system as claimed in claim 2, wherein the system output shaft is aligned parallel to the system input shaft.

9. A transmission system as claimed in claim 2, wherein the first and second clutches are selectively connectable to a common clutch output plate connected to the system output shaft.

10. A transmission system as claimed in claim 3, wherein the first and second clutches are selectively connectable to a common clutch output plate connected to the system output shaft.

11. A transmission system as claimed in claim 2, wherein the drives from the first and second gearing output shafts are transmitted to one side of the first and second clutches respectively by means of gearing.

12. A transmission system as claimed in claim 3, wherein the drives from the first and second gearing output shafts are transmitted to one side of the first and second clutches respectively by means of gearing.

13. A transmission system as claimed in claim 4, wherein the drives from the first and second gearing output shafts are transmitted to one side of the first and second clutches respectively by means of gearing.

14. A transmission system as claimed in claim 2, wherein the first clutch is engaged to place the transmission in low regime and the second clutch is engaged to place the transmission in high regime.

15. A transmission system as claimed in claim 3, wherein the first clutch is engaged to place the transmission in low regime and the second clutch is engaged to place the transmission in high regime.

16. A transmission system as claimed in claim 4, wherein the first clutch is engaged to place the transmission in low regime and the second clutch is engaged to place the transmission in high regime.

17. A transmission system as claimed in claim 5, wherein the first clutch is engaged to place the transmission in low regime and the second clutch is engaged to place the transmission in high regime.

18. A motor vehicle comprising a transmission system as claimed in claim 2.

19. A motor vehicle comprising a transmission system as claimed in claim 3.

20. A motor vehicle comprising a transmission system as claimed in claim 4.
